(19) United States
(12) Patent Application Publication
(10) Pub. No.: US 2015/0015654 A1
(43) Pub. Date: Jan. 15, 2015

(54) ROLLERS FOR A PRINTER AND A PRINTER EQUIPPED WITH SAID ROLLERS

(71) Applicant: Bixolon Europe GmbH, Dusseldorf (DE)

(72) Inventor: Armin Pietza, Dormagen (DE)

(21) Appl. No.: 14/367,026

(22) PCT Filed: Dec. 18, 2012
(86) PCT No.: PCT/EP2012/075984

§ 371 Date: Jun. 19, 2014

(30) Foreign Application Priority Data
Dec. 22, 2011 (DE) 102011112100.3

(51) Int. Cl. B41J 13/076; B41J 11/70; B41J 11/057; B41J 3/407

(52) U.S. Cl. CPC B41J 13/076; B41J 3/4075; B41J 11/703; B41J 11/057
USPC 347/110; 428/192; 428/194; 492/30

(57) ABSTRACT

The invention relates to a roller (R) for a printer for printing on print material (D) which on its side (D_{R}) facing away from the side (D_{D}) to be printed on is coated or can be coated in certain areas with an adhesive or sticking material (K), wherein the roller (R) serves to convey the print material or to press the print material against a print head or print cylinder (DKW) and the roller (R) has at least one pressing area (BA) and the pressing area (BA) serves to butt against and press onto the print material (D), characterised in that the pressing area (BA) or the pressing areas together has or have a width (B_{BA}) which is less than the width (B_{D}) of the print material (D).

The present invention relates to a printer for printing on materials which on their sides facing away from the sides to be printed on are coated in certain areas with an adhesive or sticking material.

In the case of printers which print onto bands which have a sticking or adhesive layer, there is the problem that the cutting blades and conveying rollers get contaminated by the sticking agent or adhesive and lose their function or the moveable parts of the printer become stuck due to the adhesive materials. Cleaning the cutting device or the conveying rollers is generally not possible or too expensive, with the result that the cutting device as a module has to be exchanged. If the rollers become sticky, the printer can only be made to function properly again by exchanging or cleaning the rollers.

If self-adhesive print materials were to be printed on, up to now carrier foils have always been used, in which the self-adhesive labels had to be removed from the carrier foil after the printing process and then they could be stuck onto a surface.

However, the use of a carrier foil has the disadvantage that as a result the print material is relatively thick, so that only a few labels can be wound onto a roller. The carrier foil also has to be separately disposed of after removal. The “liner-less” print materials which are also known today, on the other hand, have the advantage that they do not need a carrier foil. However, they cannot be printed on using conventional printers, since the sticking or adhesive material makes the printer sticky and unable to function.

A printer for printing on print media, which have a sticking or adhesive layer on their rear side facing away from the side to be printed on, is known from U.S. Pat. No. 5,725,320. In order that the band-shaped print medium can be conveyed in the printer, the sticking or adhesive layer extending over the entire width of the print medium is divided in the conveying direction at equidistant intervals by sticking material free or adhesive free areas, so that in these areas conveying rollers can grip the print medium without the conveying device in the process coming into contact with the sticking or adhesive layer and hence it cannot get contaminated. The conveying device known from U.S. Pat. No. 5,725,320 requires drive wheels, the design of which is complicated.

The object of the present invention is to provide a simple roller for a printer and a printer having a roller or rollers, which are simple in their design and enable the print material to be conveyed and printed on in a sufficiently reliable manner.

This object is advantageously achieved by a roller having the features of claim 1. Advantageous embodiments of this roller emerge through the features of Sub-claims 1 to 7. A printer is also claimed which has the roller(s) according to the invention according to any one of claims 1 to 7 or can move a roller by means of a drive or manually transverse to the conveying direction, so that the roller does not come into contact with the adhesive or sticking material. In addition, a print material having the features of claim 12 is claimed which can be further developed by the features of claims 13 to 15.

The invention is based on the concept that the roller only touches or presses onto the print material where the print material has no coating consisting of adhesive or sticking material. The entire print material can be printed on depending on the printer type and arrangement of the sticking or adhesive material on the print material. If the whole print surface is required to be impressed, the printer can only print on the areas of the print material which are pressed against the print cylinder or the print head by means of the pressing area of the roller according to the invention.

The printers equipped with the roller(s) according to the invention can print on band-shaped print materials, such as paper rolls, which have one or more strips consisting of sticking material or adhesive extending in the conveying direction of the print material. The roller does not in the process come into contact with the sticking material or adhesive, so that the printer does not get contaminated by the sticking material or adhesive and as a result its function is not impaired. Existing printers can be advantageously retrofitted with the roller(s) according to the invention, so that these printers are then able to print on print materials coated with sticking material or adhesive.

Hence, “linerless” print materials which do without carrier foils can also advantageously be printed on using the rollers and printers according to the invention and particularly also using the printers retrofitted with the rollers according to the invention. Therefore, using the printer with the same dimensions, rolls can be printed on which have considerably more labels. If a printer before being modified could print on print materials which had a carrier foil and the roll could hold print material 47, then the same modified printer can accommodate “linerless” print materials, in which the roll holds approximately 120 labels of the same size.

If a tearing-off device for severing or tearing off the print material already printed on is used, the sticking or adhesive strips can be formed unbroken, since the functioning of a tearing-off device is not impaired by the adhesive or sticking material.

If, however, the printer has an automatic cutting device, then it makes sense for the strips consisting of sticking or adhesive material to be divided at intervals in the conveying direction by non-coated areas, so that the print material can always be severed by the cutting device in the non-coated areas and hence it does not become contaminated. For this purpose, the printer can advantageously have a sensor for detecting the non-coated areas, so that the cutting blades do not come into contact with the sticking material or adhesive.

The roller according to the invention is characterised by the fact that the width of its pressing area is less than the width of the print material. Therefore, an area remains on the print material which can be coated with sticking material or adhesive. Thus, a strip of sticking material or adhesive can be used. A Post-It® can thereby be produced in each case which can be separated from the rest of the print material by tearing it off or cutting it off triggered automatically or manually by means of a cutting device. The strip is to be arranged advantageously on one edge of the band-shaped print material.

However, it is, of course, also possible for the strip consisting of sticking material or adhesive to be arranged in the middle of the band-shaped print material. The middle of the print material, i.e. in the area of the strip consisting of sticking material or adhesive, can have a perforation which extends in the conveying direction or longitudinal extension direction of the print material. The print material in this case has print areas on the left and on the right transverse to the conveying direction. After separating the print material printed on, the two print areas can then be separated from one another by manually splitting them along the perforation and stuck onto any surface.

If a printer is to print both on print materials which have a sticking or adhesive layer and on print material without a corresponding sticking or adhesive layer, then it is usually required that the print material without a sticking or adhesive layer is able to be printed on over its entire width. In order to solve this problem, the invention makes provision for the roller to be able to be moved by means of a drive or manually transverse to the conveying direction of the print material. The roller has a pressing area BA which is as wide as the uncoated print material. The drive moves the roller such that when printing on print materials without a sticking or adhesive layer the roller butts against the print material with its pressing area over the entire width. If the same printer is to print on a print material which has a sticking or adhesive layer on one longitudinal edge, then the roller is transversely moved by means of the drive or manually in such a way that the roller only presses with its pressing area against the print material in the area which is not coated with a sticking or adhesive layer.

The roller according to the invention can, of course, be used in thermal printers, laser printers, ink jet printers or dot matrix printers.

The roller according to the invention, the printer according to the invention and the print material according to the invention are explained in more detail below with the aid of drawings.

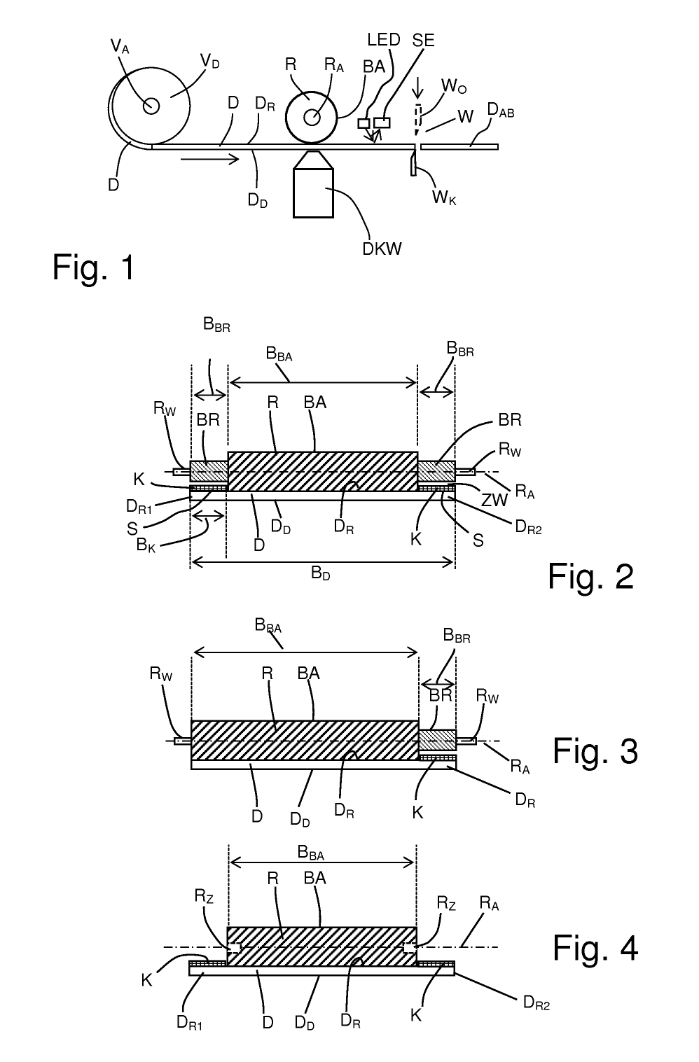

FIG. 1: shows a schematic cross-sectional representation through a printer according to the invention in a simplified illustration;

FIG. 2: shows a cross-sectional representation through a first embodiment of the roller according to the invention with pressing area butting against the print material;

FIG. 3: shows a cross-sectional representation through a second embodiment of the roller according to the invention with pressing area butting against the print material;

FIG. 4: shows a cross-sectional representation through a third embodiment of the roller according to the invention with associated print material;

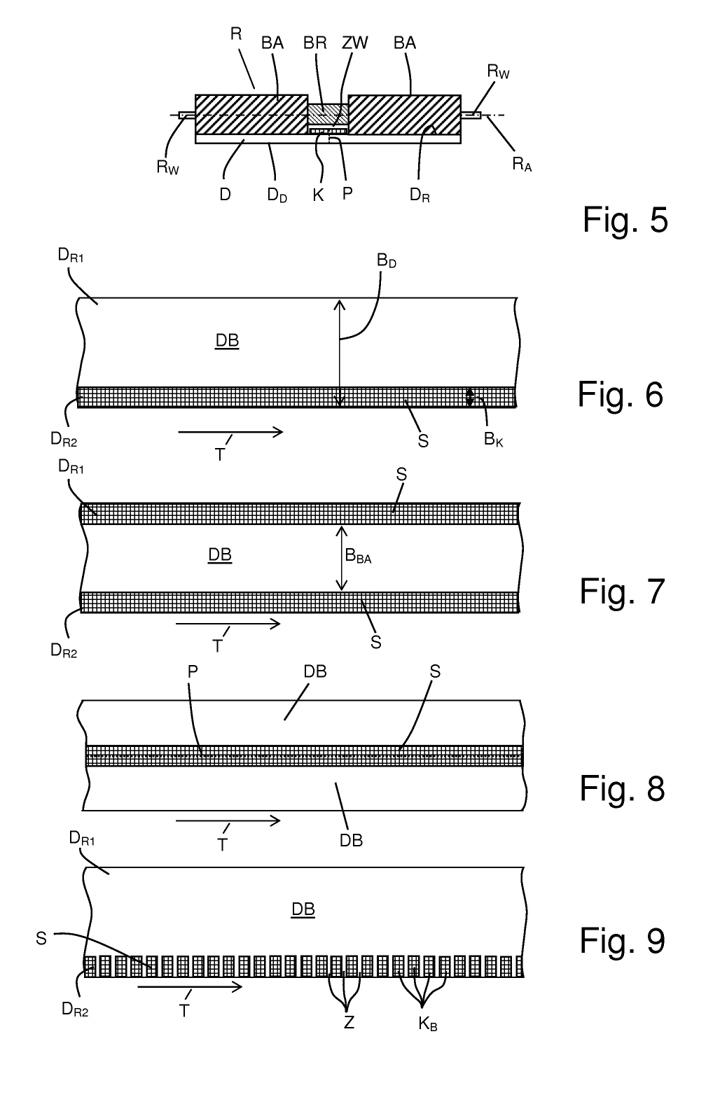

FIG. 5: shows a cross-sectional representation through a fourth embodiment of the roller according to the invention with associated print material;

FIG. 6: shows a plan view of a print material having one strip of sticking or adhesive material for a roller according to FIG. 3;

FIG. 7: shows a plan view of a print material having two strips of sticking or adhesive material for a roller according to FIG. 2;

FIG. 8: shows a plan view of a print material having one strip of sticking or adhesive material for a roller according to FIG. 5;

FIG. 9: shows a plan view of a print material having a strip of sticking or adhesive material interrupted in the conveying direction for a printer with an automatic cutting unit;

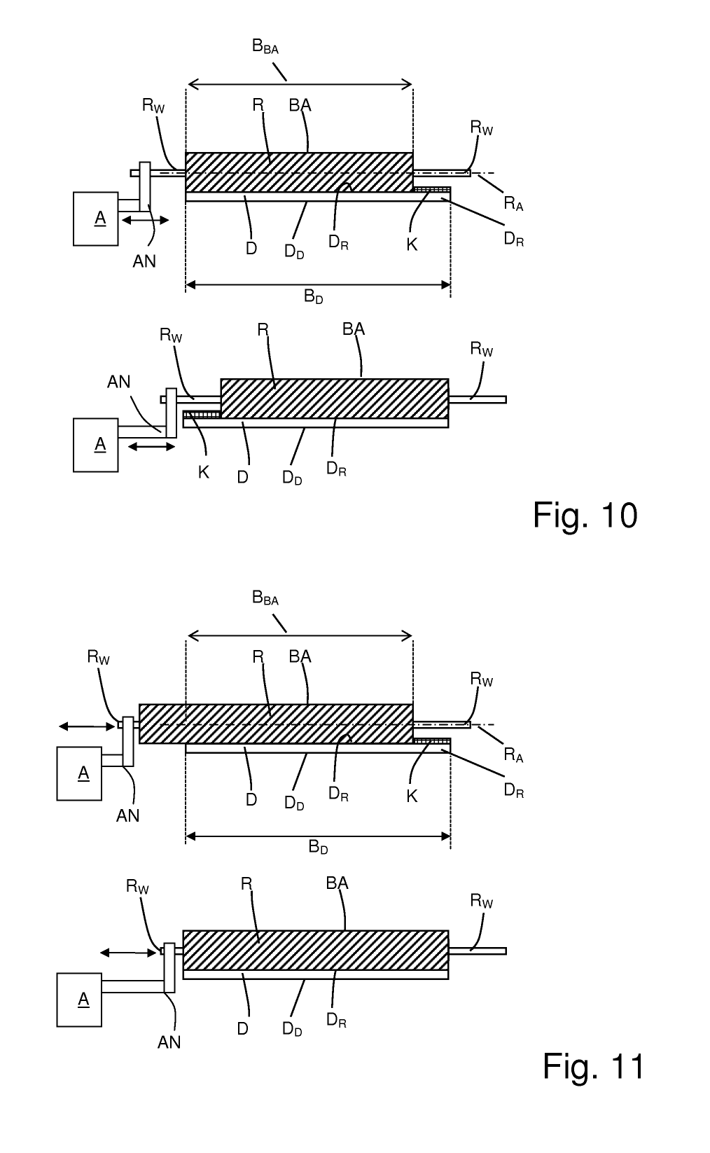

FIG. 10: shows a printer having a drive for moving the roller transverse to the conveying direction of the print material, wherein the roller is narrower than the width of the material to be printed on;

FIG. 11: shows a printer having a drive for moving the roller transverse to the conveying direction of the print material, wherein the roller is at least as wide as the material to be printed on.

FIG. 1 shows a schematic cross-sectional representation through a printer according to the invention in a simplified illustration. The printer has a supply roller V_{D}, onto which the print material D to be printed on is rolled and which is rotatably mounted about its axis V_{A} in the printer. Often, a spindle is not provided for the supply roller V_{D} and instead the roller V_{D} is freely movable in a housing compartment of the printer. The print material D is conveyed in the arrow direction T and has a side D_{D} to be printed on and a rear side D_{R} which is coated in certain areas, in particular with a strip of sticking or adhesive material K. The roller R conveys the print material D and presses onto the print head DKW and guides the print material D past the print head DKW respectively. The roller R is rotatably mounted in the printer about its axis R_{A} and has at least one pressing area BA, with which the roller R butts against the rear side D_{R} of the print material D and applies pressure onto it. The roller R can be driven by means of a drive to convey the print material D.

A cutting unit or a tearing-off device W can be optionally arranged behind the print unit DKW in the conveying direction T, by means of which the print material D_{AB} already printed on can be separated from the band-shaped print material D. The cutting unit DKW can either perform the separation process fully automatically or it can be manually triggered or activated. The tearing-off device only requires a blade W_{K}. The cutting device, on the other hand, requires a further blade W_{O} which must be moved relative to the first blade W_{K} in the arrow direction in order to perform the cutting-off process.

It is also optionally possible for at least one additional drive roller to be provided for transporting the print material D in the printer. This roller can also be formed by a roller R according to the invention. This drive roller should also not come into contact with the sticking or adhesive material K.

The print material D can be printed on directly after a computer has submitted the print job. It is, however, also possible to provide an input means, e.g. in the form of an operating button, by means of which the print process can be manually triggered. This is always useful if the person operating the computer only wants the print out the job at a specific time.

If a print material D is used as illustrated in FIG. 9, optionally another sensor device SE can be installed, so that the printer can control the conveying of the print material D in such a way that the cutting device DKW always severs the print material D in an area Z which is free of sticking material or adhesive. Here, an LED, for example, can emit light onto the rear side D_{R} of the print material D. The light reflected by the rear side D_{R} is detected by the sensor device SE. The sticking or adhesive layer K reflects the light differently from the uncoated rear side D_{R} of the print material, whereby the control device of the printer can control the conveying of the print material D accordingly. Of course, the areas Z or K_{B} can also be detected differently.

FIG. 2 shows a cross-sectional representation through a first embodiment of the roller R according to the invention with pressing area BA butting against the print material D. The roller R forms the pressing area BA with its middle and this pressing area BA butts against the rear side D_{R} of the print material which is not coated with adhesive or sticking material K. The print material D has a width B_{D} and has on its rear side D_{R} two stripes S consisting of sticking material or adhesive K which cover the edge areas D_{R1} and D_{R2}. The width B_{K} of the strips S is the same or slightly less than the width B_{BR} of the recess areas BR of the roller R which abut on the pressing area BA on both sides. It is hereby ensured that the roller R does not come or only slightly comes into contact with the sticking or adhesive material K. The roller R is hence reliably prevented from becoming contaminated or sticky. The width B_{BA} of the pressing area BA is hence the same or less than the width B_{D} minus twice the width B_{K}.

The recess areas BR each have a diameter D_{BR} which is less than the diameter D_{BA} of the pressing area BA. Care must be taken that the recess of the diameter from the pressing area BA to the recess area BR is large enough for a gap ZW to exist between the sticking or adhesive material K and the circumferential surface of the recess area BR of the roller, so that there is no contact.

The roller R in addition has spindle projections R_{W} on its axial end faces, by means of which the roller R is mounted in the printer. As is shown in FIG. 4, it is, however, also possible for the roller R to have indentations R, on its axial end faces, with which the bearing journals of the printer engage and hence with which the roller is rotatably mounted about its axis R_{A}.

FIG. 3 shows a cross-sectional representation through a second embodiment of the roller R according to the invention with pressing area BA butting against the print material D, wherein the print material D only has one strip of sticking or adhesive material K on its rear side D_{R}. As a result, the roller R also only has to have one recess area BR, the diameter D_{BR} of which is less than the diameter D_{BA} of the pressing area BA.

FIG. 4 shows a cross-sectional representation through a third possible embodiment of the roller R according to the invention with associated print material D, wherein the roller R has no recess area BR. The roller R is solely formed by the pressing area BA, the width of which corresponds to the width of the non-coated area between the sticking or adhesive material strips K or is slightly less than it. The roller has indentations R, on its axial end faces, with which bearing journals of the housing can engage. It is, of course, possible for the roller R to also have spindle projections R_{W} instead of indentations R, as illustrated in FIGS. 2 and 3. The print material D is formed identically to the print material D described in FIG. 2 and to avoid repetition is not described again here.

FIG. 5 shows a cross-sectional representation through a fourth possible embodiment of the roller R according to the invention with associated print material D, wherein here the strip S of the sticking or adhesive material K is arranged in the middle of the band. As a result, the recess area BR of the roller R is also arranged in the middle of the roller between two abutting pressing areas BA. A perforation P extending along the conveying direction T is illustrated in FIG. 5, which can be optionally provided, so that the print material D_{AB} printed on (see also FIG. 1), after it has been detached from the print material D which has still not been printed on, can be separated into two halves which e.g. can be printed on differently or identically.

Of course, it is also possible for more than one longitudinal perforation P to be provided. In the case of the embodiment according to FIG. 5, it is also possible for more than one strip of sticking or adhesive material K to be provided on the rear side.

FIG. 6 shows a plan view of a print material D having one strip S of sticking or adhesive material K for a roller R according to FIG. 3. The width B_{K} of the strip S determines the width of the recess area BR and the width of the pressing area BA.

FIG. 7 shows a plan view of a print material D having two strips S of sticking or adhesive material K for a roller R according to FIG. 2, wherein the strips S are arranged in the edge areas D_{R1} and D_{R2} of the print material D.

FIG. 8 shows a plan view of a print material D having one middle strip S of sticking or adhesive material K for a roller R according to FIG. 5. The optional perforation is in the middle of the band, whereby to the left and right of the material strip S, K an area DB to be printed on is present. According to requirements, both print areas DB can be printed on and can be separated after they have been detached from the roller V_{D}.

FIG. 9 shows a further possible embodiment of the print material, wherein here the strip S is arranged in the edge area D_{R2}. The strip S is formed by sticking or adhesive material areas K_{B}, which are spaced apart from one another by sticking material free or adhesive free areas Z in the conveying direction T. The print material D with its areas Z can now be arranged relative to the cutting unit DKW such that the blades WK and WO sever the print material between the areas KB and hence do not come into contact with the material K and thereby also cannot become contaminated and sticky.

FIGS. 10 and 11 show an embodiment of a printer having a drive for moving the roller transverse to the conveying direction of the print material. The only difference between the two embodiments is the different width of the roller R relative to the width B_{D} of the print material D. In the embodiment illustrated in FIG. 10, the width B_{BA} of the roller R is less than the width B_{D} of the print material. Thus, print material D can be selectively printed on, in which the adhesive or sticking layer K is arranged either on the one longitudinal side or on the other longitudinal side of the print material D. According to which print material is inserted into the printer, the drive A by means of the gear mechanism AN moves the roller R in the arrow direction transverse to the conveying direction of the print material or parallel to the axis of the roller R.

As illustrated in FIG. 11, the width of the roller B_{BA} or its pressing area can also be the same as the width B_{D} of the print material D. In the lower illustration in FIG. 11, a print material D without a sticking or adhesive layer is printed on, wherein the pressing area BBA [sic: BA?] of the roller presses against the print material D over the entire width B_{D}, whereby the side D_{R} can be printed on over its entire width B_{D}. If print material D coated with an adhesive or sticking layer K is to be printed on using the same printer, then the roller R, as illustrated in the upper illustration in FIG. 11, is moved to the left beyond the edge of the print material D, so that the roller in area of the sticking or adhesive layer K no longer butts against the print material D and hence does not disadvantageously come into contact with the sticking or adhesive material K.

The drive A can be controlled by a printer control unit which is not illustrated and is not described in more detail. It is possible for the printer to identify the print material to be printed on independently and move the roller correspondingly transverse to the conveying direction of the print material or in the axial direction of the roller. It is also possible for the type of print material to be pre-specified to the printer, e.g. by means of an input via an operator interface of the printer or by moving a switch in or on the printer housing.

Of course, the printer can also be formed without a drive, wherein the roller R according to the print material inserted then has to be aligned by hand transverse to the conveying direction of the print material D. At the same time, e.g. the axial end stops for the roller can be correspondingly moved. However, it is also possible for the roller to lock in place on its axis or with its axis in the housing in at least two positions transverse to the conveying direction of the print material, wherein the roller can, of course, be further turned about its axis.

1. A roller for a printer for printing on print material that, on a side facing away from a side to be printed on, is coated or can be coated in certain areas with an adhesive or sticking material, roller including:
at least one pressing area configured to butt against and press onto the print material,
wherein the roller is configured to convey the print material or to press the print material against a print head or print cylinder, and wherein either:
the at least one pressing area has a width which is less than a width of the print material; or
the roller is configured to be moved transverse to a conveying direction of the print material, by means of a printer drive or manually, in such a way that the roller does not come into contact with the adhesive or sticking material of the print material.

2. The roller according to claim 1, wherein the roller further comprises at least one recess area, wherein the at least one recess area and the at least one pressing area are arranged next to one another in an axial direction of the roller.

3. The roller according to claim 2, wherein the at least one recess area is arranged relative to the adhesive or sticking material in such a way that the roller does not come into contact with the adhesive or sticking material, and wherein a diameter of the roller is less in the area of the at least one recess area than a diameter of the roller in the pressing area.

4. The roller according to claim 3, wherein the diameter in the recess area is less than the diameter of the at least one pressing area by at least a thickness of the adhesive or sticking layer of the print material.

5. The roller according to claim 1, wherein a width of the at least one pressing area of the roller is less than an axial length of the roller.

6. The roller according to claim 2, wherein the at least one pressing area and the recess area extend in a circumferential direction around the entire roller.

7. The roller according to claim 2, wherein the roller has a recess area on one or on both of its ends, wherein the recess area abuts on the at least one pressing area in an axial direction.

8. A printer comprising at least one roller according to claim 1, wherein the printer is configured to print on band-shaped print material, wherein in a conveying direction the print material has at least one continuous, uninterrupted strip of sticking or adhesive material.

9. The printer according to claim 8, further comprising a cutting unit configured to automatically cut off or sever the print material, or further comprising a tearing-off device configured to tear for tearing off the print material.

10. The printer according to claim 8, further comprising an input element configured to enable starting the printing of a sticky note.

11. The printer according to claim 8, further comprising:
at least one sensor configured to detect sticking material free or adhesive free areas or to detect sticking material or adhesive areas, and to output signals; and
a conveying device connected to receive the output signals from the at least one sensor and to be controlled by the output signals such that the print material is enabled to be positioned relative to a cutting unit such that the cutting unit is enabled to sever the print material in an area of its sticking material free or adhesive free areas.

12. The printer according to claim 8, further comprising a drive configured to alter a position of the at least one roller relative to the print material, in a transverse direction to the conveying direction of the print material.

13. The printer according to claim 12, wherein the printer is configured to print on print material with or without a sticking or adhesive layer wherein the printer is configured to detect the type of print material by means of a sensor or to obtain the type of print material as input into a printer control unit, wherein the drive is configured to move the at least one roller, based on the type of print material, (D) transverse to the conveying direction of the print material.

14. The printer according to claim 8, wherein the at least one roller is enabled to be moved transverse to the conveying direction of the print material, wherein the roller is configured to be fixed or locked in place in at least two positions, in which it can be further turned about its axis in such a way that the at least one roller can be arranged in at least two positions with respect to the print material in the transverse direction to the conveying direction of the print material.

15. Print material for the printer according to claim 8, wherein the print material input to the printer has a strip of sticking or adhesive material on and area adjacent to one of its edges, along the conveying direction, or on areas adjacent to both of its edges, along the conveying direction.

16. The print material according to claim 15, wherein the strip(s) is or are continuous or is or are interrupted at regular intervals by sticking material free or adhesive free areas in the conveying direction.

17. The print material according to claim 15, Wherein the print material is band-shaped and is wound onto a roller.

18. The print material according to claim 15, wherein the print material has at least one longitudinal strip of adhesive or sticking material in a transverse direction to the conveying direction, wherein the at least one longitudinal strip extends over a part of a width of the print material.
